(19) United States
(12) Patent Application Publication
(10) Pub. No.: US 2020/0190893 A1
(43) Pub. Date: Jun. 18, 2020

(54) Decorative SMC Door Facing and Method of Making Same

(71) Applicant: Xianying Guo, Qinhuangdao City (CN)

(72) Inventor: Xianying Guo, Qinhuangdao City (CN)

(21) Appl. No.: 16/791,493

(22) Filed: Feb. 14, 2020

(30) Foreign Application Priority Data
Dec. 17, 2018 (CN) 201822116371.2

(51) Int. Cl. E06B 3/70

(52) U.S. Cl. CPC E06B 3/7001

(57) ABSTRACT

The invention discloses a one-piece molded SMC door facing with a decorative strip and preparation process thereof. The door facing body and the decorative strip made of the same SMC are molded into the one-piece door facing by a molding process at one time. At least two decorative lattices (windows) are formed by the decorative strips. The invention solves the traditional process of artificially adhering decorative strips, with high quality and high production efficiency, and a single mold investment can generate huge economic benefits. At the same time, the decorative strip and the door facing are molded by the same SMC, which eliminates the color difference between the decorative strips and the door facing. There is no longer any gap between the decorative the strips or between decorative strip and the door glass sticking; the products produced by this preparation process have good strength and no deformation.

### BACKGROUND

### Technical Field

The invention relates to a one-piece molded SMC door facing with a decorative strip for producing a SMC material door and a preparation process thereof, which belongs to the technical field of the construction industry.

### Description of the Related Art

SMC (Sheet Molding Compound) doors with decorative glass are widely used as exterior doors for residential buildings in countries such as the US and Canada due to their advantages such as being waterproof, energy saving, and providing a beautiful appearance etc. The most popular decorative glass is glass with decorative strips that is used to simulate the style of traditional wooden doors. Currently, the material of decorative strip(s) is generally vinyl plastic. The production method is to first cut the extruded plastic decorative strip with double-sided tape at the bottom to a fixed length, and then process the ends of the cut plastic decorative strip into special shapes according to the profile curve of the door glass sticking, and then manually bonding each decorative strip to the surface of insulating glass in the frameless SMC door. There are three drawbacks existing in this manually bonded plastic strip: first is the material of the plastic strips and the SMC door facing are inconsistent which results in a color difference between the decorative strips and the door; second the gap between decorative strips and the gap between the decorative strips and door teeth result in unsightly look; and third, manually bonding decorative strips to the glass is very labor-intensive and costly.

The method of producing window or door glass with decorative strips are described in the following U.S. patents (U.S. Pat. Nos. 4,598,520; 4,783,938; 6,177,156; 7,854,097; 5,088,255; 6,550,204), but the cores of all disclosed production methods are manually bonding or fixing the fixed length decorative strips on the glass. For example, in U.S. Pat. No. 4,783,938, the applicant discloses a window design with metallic internal muntin bars and wooden exterior muntin bars. Intersecting metallic internal muntin bars are disposed in the space between two glass panes, and then prefabricated wooden exterior muntin bars are manually bonded on the surface of the insulating glass where the position corresponds to the metallic internal muntin bars.

### SUMMARY OF THE INVENTION

The present invention provides a one-piece molded SMC door facing with a decorative strip and preparation process thereof, which has overcome the drawbacks in the prior art of manual bonding vinyl plastic decorative strips onto frameless SMC doors. In the present invention, the decorative strip and the door facing are designed as a whole, and the same SMC material is used to directly mold the decorative strip and the door facing at one time. After the mold is closed, a SMC material door facing with a decorative strip is automatically formed, which completely solves the process of manually bonding the decorative strip. It greatly increases the production efficiency and significantly reduces the production cost.

The technical solution adopted by the present invention to solve its technical problems is: a one-piece molded SMC door facing with a decorative strip, comprising a door facing body and a decorative strip, both door facing body and the decorative strip are made of SMC. The one-piece molded SMC door facing with a decorative strip is a one-piece door facing formed by one-time molding of the decorative strips used for glass as an opening and the door facing body. At least two decorative lattices(windows) are formed by the decorative strips, the decorative lattice (window) generally has 2 lattices, 3 lattices, 4 lattices, 6 lattices, 8 lattices, 9 lattices, 10 lattices, 12 lattices, 15 lattices or 18 lattices and the like, and the decorative lattice is presented as rectangular, diamond, or an irregular shape. The cross-section pattern of the decorative strip may be a commonly used pattern(s), and different numbers of decorative lattices and the decorative strips with different cross-section pattern are made by a different designed mold.

In addition, this application provides a process for preparing a one-piece molded SMC door facing with a decorative strip, comprising the following steps:

a. Feeding: weighing the materials of a door facing body and the materials of decorative strip such that the material weight of the door facing body is 101%-105% of its theoretical weight and the materials of the decorative strip is 115%-120% of its theoretical weight, the materials of the door facing body and the materials of the decorative strip are SMC;

b. Placing materials: placing the materials of the door facing body and the materials of the decorative strip on the lower die of the mold, connecting the material blocks and making them overlap each other, wherein the door facing body comprises an upper crossbar portion at the above end of the door body, a lower crossbar portion comprising a door core panel portion at the below end of the door body, a door edge, a lap joint part, a trim strip and a rib. The material blocks of the lower crossbar portion are centered in the mold.

c. Pressing mold: closing the mold after placing the materials, heating the mold until the mold reaching a certain temperature, and then pressing the mold for a certain time, so that the door facing body and the decorative strips are formed in one-piece, wherein the temperature of the mold is provided as 135-150° C., and the time of pressing the mold is provided as 190-230 s.

d. Demolding: opening the mold and obtaining the one-piece product from the mold after completing the step of pressing mold, wherein the product is located in the upper die of mold when the mold is opened.

The beneficial effect of the present invention is: decorative strips used for decorating the glass are integrally molded at an opening for glass of the SMC door facing with a decorative strip. Then, the frameless SMC door with the decorative strip is produced by overall foaming according to the common production process of the ordinary SMC door or filling with thermal insulation material between the two one-piece SMC door facings. The product appearance of the invention is comparable to that of solid wood doors, with high quality, labor saving, high production efficiency, and a single mold investment can produce huge economic benefits. At the same time, the decorative strip and the door facing are molded by the same SMC material, which eliminates the color difference between the decorative strip and the door facing, and there is no longer any gap between the decorative strips and between the decorative strip and the door teeth, its appearance is very exquisite. The door facing body and the decorative strips are made in one piece by the process for preparing a one-piece molded SMC door facing with a decorative strip, there is no color difference between the produced decorative strips and the door facing, and the strength of the product is good.

### BRIEF DESCRIPTION OF THE DRAWINGS

FIG. 1 is a front view of a one-piece molded SMC door facing with a decorative strip having 6 decorative lattices;

FIG. 2 is a cross-sectional view taken along lines A-A of a one-piece molded SMC door facing with a decorative strip having 6 decorative lattices;

FIG. 3 is a part I enlarged view of a section of the decorative strip in a horizontal position in the one-piece molded SMC door facing with a decorative strip having 6 decorative lattices;

FIG. 4 is a cross-sectional view taken along lines B-B of a one-piece molded SMC door facing with a decorative strip having decorative lattices;

FIG. 5 is a part II enlarged view of a section of the decorative strip in a vertical position in the one-piece molded SMC door facing with a decorative strip having 6 decorative lattices;

FIG. 6 is a front view of the one-piece molded SMC door with a decorative strip having 6 decorative lattices and installing insulating glass;

FIG. 7 is an exploded view of a one-piece molded SMC door with a decorative strip having 6 decorative lattices;

FIG. 8 is a top view of the lower die of the mold used for the one-piece molded SMC door facing with a decorative strip having 6 decorative lattices;

FIG. 9 is a schematic view of a way of placing materials on the lower die of the mold.

In the above drawings, the reference numbers are as follows: 1—vertical edge 2—decorative strip, 3—decorative lattice (window), 4—door core panel, 5—lateral edge, 6—insulating glass, 7—inner frame, 8—edge frame, 9—polyurethane insulation material, 10—one-piece molded SMC door facing with a decorative strip; 11—upper crossbar portion, 12—lower crossbar portion; 13—door edge; 14—lap joint part; 15—trim strip; 16—rib; 17—mold.

### DETAILED DESCRIPTION OF THE PREFERRED EMBODIMENT

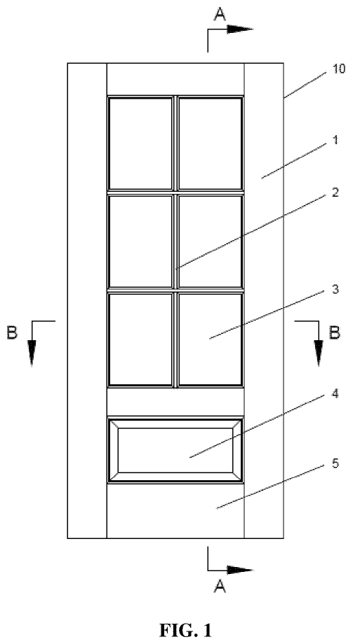

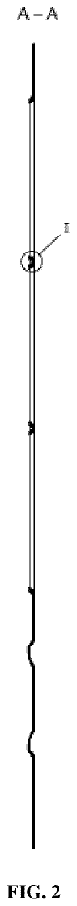

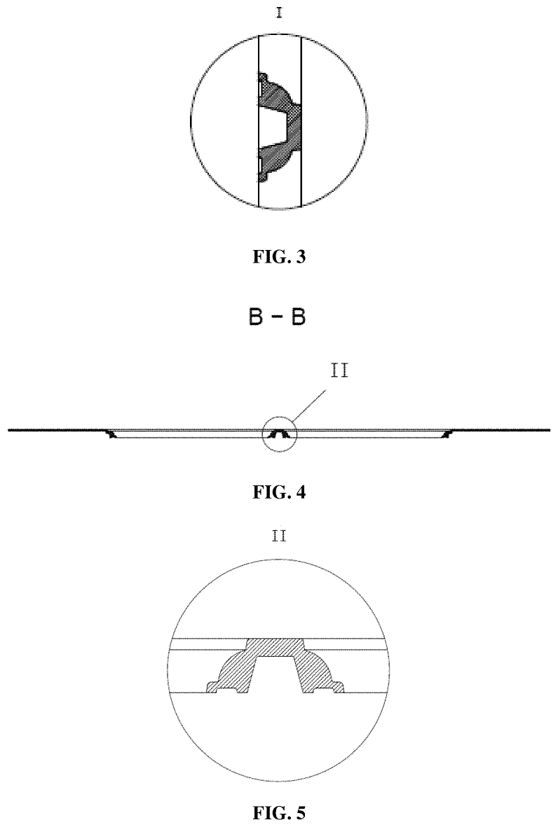

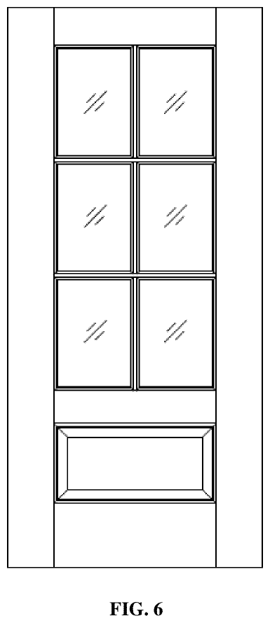

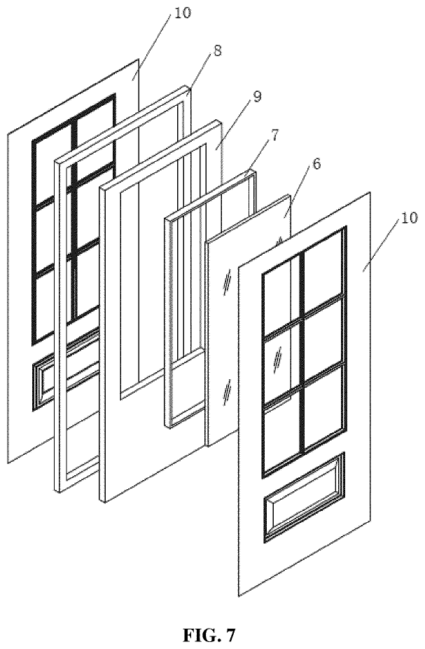

As shown in FIGS. 1 to 7, the one-piece molded SMC door facing with a decorative strip (10) having 6 decorative lattices (windows) (3) is composed of two vertical edges (1), one door core panel (4), and three lateral edges (5) and decorative strips (2) (comprising horizontal and vertical decorative strips). The decorative strips (2) is made of the same material as the door facing body, and all the above components are molded into a one-piece door facing having 6 decorative lattices (windows) (3) at one time. The raw material used for molding the one-piece door facing is a thermosetting SMC material.

At least two decorative lattices (windows) (3) are formed by the decorative strips (2) of the one-piece molded SMC door facing with a decorative strip to simulate the glass style of traditional wooden doors/windows. The insulating glass (6) is installed at the opening for the insulating glass between the two door facings (10), an inner frame (7) is used to fix and maintain being alignment with the opening for glass. The decorative strip (2) is pressed on the outer surface of the insulating glass (6). After an edge frame (8) is added, the one-piece molded SMC door facings with a decorative strip (10) will be adhered to the edge frame (8) and the inner frame (7) and then filled with a polyurethane insulation material (9) to make a SMC door with decorative strip(s). If it is necessary to change the number or style of the decorative lattice, it can be achieved as long as the corresponding mold is made. As can be seen, the present invention is particularly suitably used for large-scale production.

In addition, the amount involved, the parameters of mold and operation are extremely critical factors for producing a qualified door facing. In the present invention, the one-piece molded SMC door facing with a decorative strip having 6 decorative lattices is taken as an example to state its preparation process: the process of feeding, placing materials, pressing mold and demolding to obtain the product from the mold.

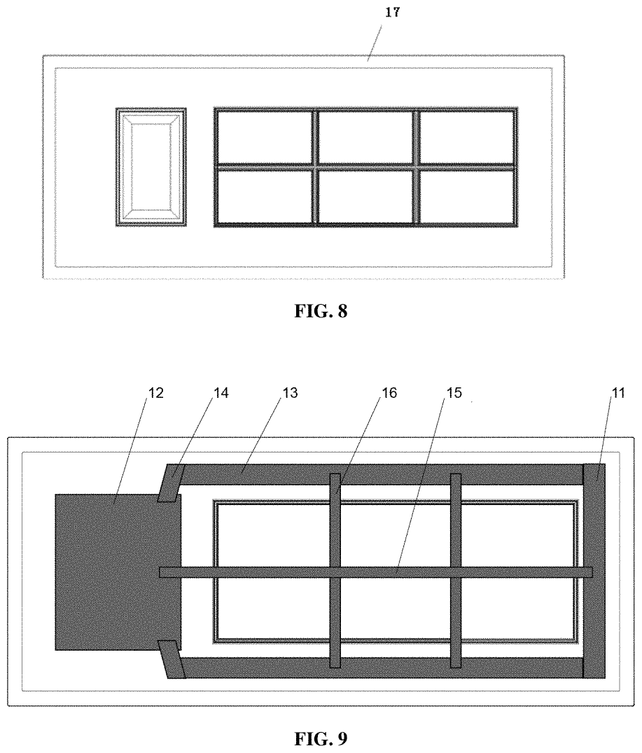

FIG. 8 is a top view of the lower die of the mold (17) having 6 decorative lattices, the steps of the preparation process are as follows:

a. Feeding: the materials of a door facing body and the materials a decorative strip are weighed preferred by electronic scale such that the materials weight of the door facing body is 101%-120% of its theoretical weight and the materials of the decorative strip is 115%-120% of its theoretical weight, which can prevent the problem that the insufficient weight may easily cause the product to be partially out of stock or the overweight may change the thickness of door. The material of the door facing body and the materials of the decorative strip are SMC.

b. Placing materials: the materials of the door facing body and the materials of the decorative strip are placed on the lower die of the mold (17), the material blocks must overlap each other, otherwise the joints may not be strong enough to prevent breakage (partially without glass fiber) and cause defective products. As shown in FIG. 9, the door facing body comprises the upper crossbar portion (11), the lower crossbar portion (12) (comprising the door core panel), two door edges (13), two lap joint parts (14), one trim strip (15) and some ribs (16), that is, nine material blocks contained in the door facing body are placed which fall into six categories. Moreover, because the area of the lower crossbar portion is relatively large due to the door core board, thus, it is preferable to center the material block of the lower crossbar portion (12) in the mold, otherwise, the physical flow distance during molding is relatively long, and it will be hardened without flowing in place that resulting in edge defects and defective products.

c. Pressing mold: after the materials are placed the mold is closed. Then the mold is heated until it reaches at a certain temperature, and then the mold is pressed for a certain time, so that the door facing body and the decorative strips are formed in one-piece. The temperature of the mold is provided as 135-150° C. (may be fine-tuned according to the ambient temperature and the actual molding effect), such as 135° C., 150° C., 145° C., etc., which is not permitted to be too high. In the door facing body, because the thickness of the ribs is thicker (approximately 3 times) than the thickness of other parts of the door facing body, the time of pressing the entire mold is correspondingly provide as 190-230 s (may be fine-tuning according to the ambient temperature and the actual molding effect), such as 190 s, 210 s, or 230 s etc.

d. Demolding: the door facing has been pressed after the pressing the mold is completed, and then the mold is opened and the one-piece molded product is obtained from the mold. Because the front surface of the product has wood grain and decorative strips, it is preferable that the product is located in the upper die of the mold when opening the mold.

Finally, this embodiment also shows a door comprising a door facing main body and a decorative strip, the door facing body and the decorative strips is formed in one-piece, and the material of the door facing body and the material of the decorative strips are both the SMC material, that is, the door facing of the present invention can be applied to various doors.

The foregoing descriptions of the embodiments and their accompanying drawings of the invention are intended to illustrate and not to limit this invention. Various changes and modifications may be made to the embodiments without departing from the spirit of the invention. Therefore, the scope of the invention is to be limited only by the appended claims.

1-8. (canceled)

9. A one-piece molded sheet molding compound (SMC) door facing with a decorative strip, comprising a door facing body and a decorative strip, wherein the door facing body and the decorative strip made of the same SMC are molded into the one-piece molded SMC door facing with a decorative strip by a molding process at one time, and wherein at least two decorative lattices are formed by decorative strips.

10. The door facing of claim 9, wherein the at least two decorative lattices have 2 lattices, 3 lattices, 4 lattices, 6 lattices, 8 lattices, 9 lattices, 10 lattices, 12 lattices, 15 lattices, or 18 lattices, and the at least two decorative lattices is are presented as a rectangle, diamond, or irregular shape.

11. The door facing of claim 9, wherein different numbers of decorative lattices and decorative strips with different cross-section patterns are made by a different designed mold, and the cross-section pattern of the decorative strip may be a commonly used pattern.

12. The door facing of claim 10, wherein different numbers of decorative lattices and decorative strips with different cross-section patterns are made by a different designed mold, and the cross-section pattern of the decorative strip may be a commonly used pattern.

13. A process for preparing one-piece molded sheet molding compound (SMC) door facing with a decorative strip, comprising the following steps:
weighing the materials of a door facing body and the materials of a decorative strip such that the materials weight of the door facing body is 101%-105% of its theoretical weight and the materials of the decorative strip is 115%-120% of its theoretical weight, wherein the materials of the door facing body and the materials of the decorative strip are both SMC;
placing the materials of the door facing body and the materials of the decorative strip on the lower die of a mold, and connecting the material blocks and making the material blocks overlap each other;
closing the mold after completing the step of placing the materials, then heating the mold until the mold reaching a predetermined temperature, and then pressing the mold for a predetermined time so that the door facing body and the decorative strip are formed in a one-piece product; and
opening the mold and obtaining the one-piece product from the mold after completing the step of pressing the mold.

14. The process of claim 13, wherein the door facing body comprises an upper crossbar portion at an above end of the door body, a lower crossbar portion comprising a door core panel portion at a below end of the door body, a door edge contacting the upper crossbar portion, a lap joint part contacting the lower crossbar portion and the door edge, a trim strip contacting the upper crossbar portion and the lower crossbar portion, and a rib contacting the door edge and the trim strip.

15. The process of claim 14, wherein in the step of placing the materials, the process further comprising centering the material blocks of the lower crossbar portion in the mold.

16. The process of claim 14, wherein in the step of closing and pressing the mold, the temperature of the mold comprises 135-150° C., and the time of pressing the mold comprises 190-230 s.

17. The process of claim 13, wherein in the step of opening the mold, the one-piece product is located in an upper die of the mold when the mold is opened.
